(19) United States
(12) Patent Application Publication
(10) Pub. No.: US 2016/0042419 A1
(43) Pub. Date: Feb. 11, 2016

(54) METHOD AND APPARATUS FOR PROVIDING CUSTOMIZED INTERACTION EXPERIENCE TO CUSTOMERS

(71) Applicant: 24/7 Customer, Inc., Campbell, CA (US)

(72) Inventor: Bhupinder SINGH, Bangalore (IN)

(21) Appl. No.: 14/819,336

(22) Filed: Aug. 5, 2015

Related U.S. Application Data
(60) Provisional application No. 62/033,934, filed on Aug. 6, 2014.

(51) Int. Cl. G06Q 30/06

(52) U.S. Cl. CPC G06Q 30/0613; G06Q 30/0631

(57) ABSTRACT

A computer-implemented method and an apparatus for providing customized interaction experience facilitates a capturing of interaction data and non-interaction data related to one or more interactions of a customer on at least one interaction channel. The interaction data comprises information related to elements of interest to the customer from among a plurality of elements presented to the customer during the one or more interactions. The non-interaction data comprises information related to one or more remaining elements of non-interest to the customer from among the plurality of elements. An intention of the customer is predicted based on the interaction data and the non-interaction data. A customized interaction experience is provided to the customer in one or more interaction channels from among the plurality of interaction channels based on the predicted intention of the customer.

### CROSS REFERENCE TO RELATED APPLICATIONS

This application claims priority to U.S. provisional patent application Ser. No. 62/033,934, filed Aug. 6, 2014, which is incorporated herein in its entirety by this reference thereto.

### TECHNICAL FIELD

The invention relates to improving customer experiences. More particularly, the invention relates to a method and apparatus for providing customized interaction experience to customers.

### BACKGROUND

Enterprises, nowadays, interact with their existing and/or potential customers on a variety of interaction channels.

For example, an enterprise may showcase their line of product offerings to their customers on a website, i.e. use a web interaction channel, or on a native mobile application, i.e. use a native mobile interaction channel.

In another example, an enterprise may offer assistance to a customer by enabling an interaction of the customer with a customer support representative or an agent using a phone, i.e. use a speech interaction channel, or through a chat application, i.e. use a chat interaction channel.

In yet another example, an enterprise may provide the customer with a self-service option, for example, an interactive voice response (IVR) system, i.e. use an IVR interaction channel, or, with an assisted self-service option, i.e. a customer interaction involving a combination of self-service and live agents.

In still another example, the enterprise may provide promotional offers or discount schemes to their customers over e-mail, i.e. use an email interaction channel, or, display advertisements as a pop-up when the customer is active on a social medium, i.e. use a social media interaction channel.

Accordingly, enterprises may interact with their customers in one or more interaction channels. Some conventional mechanisms suggest collation and analysis of data generated on account of interactions between the enterprises and the customers to predict intention of the customers. However, a quality of prediction is limited by both a quality and quantity of the collated data. It is desirable to improve a granularity of predicted intention of a customer. Moreover, prediction of customer's intention based on gathered interaction data using conventional mechanisms is a time consuming exercise. As such, it is desirable to improve the granularity of customer intent prediction in a time-effective manner to provision a vastly improved interaction experience to the customers.

### SUMMARY

In an embodiment of the invention, a computer-implemented method includes facilitating, by a processor, a capturing of interaction data and non-interaction data related to one or more interactions of a customer on at least one interaction channel from among a plurality of interaction channels. The interaction data comprises information related to elements of interest to the customer from among a plurality of elements presented to the customer during the one or more interactions. The non-interaction data comprises information related to one or more remaining elements of non-interest to the customer from among the plurality of elements presented to the customer during the one or more interactions. The method predicts, by the processor, an intention of the customer based on the interaction data and the non-interaction data. The method provides, by the processor, a customized interaction experience to the customer in one or more interaction channels from among the plurality of interaction channels based on the predicted intention of the customer.

In another embodiment of the invention, an apparatus for providing customized interaction experience to customers includes at least one processor and a memory. The memory stores machine executable instructions therein, that when executed by the at least one processor, cause the apparatus to facilitate a capturing of interaction data and non-interaction data related to one or more interactions of a customer on at least one interaction channel from among a plurality of interaction channels. The interaction data comprises information related to elements of interest to the customer from among a plurality of elements presented to the customer during the one or more interactions. The non-interaction data comprises information related to one or more remaining elements of non-interest to the customer from among the plurality of elements presented to the customer during the one or more interactions. The apparatus predicts an intention of the customer based on the interaction data and the non-interaction data. The apparatus provides a customized interaction experience to the customer in one or more interaction channels from among the plurality of interaction channels based on the predicted intention of the customer.

In another embodiment of the invention, a non-transitory computer-readable medium storing a set of instructions that when executed cause a computer to perform a method for providing customized interaction experience to customers is disclosed. The method executed by the computer facilitates a capturing of interaction data and non-interaction data related to one or more interactions of a customer on at least one interaction channel from among a plurality of interaction channels. The interaction data comprises information related to elements of interest to the customer from among a plurality of elements presented to the customer during the one or more interactions. The non-interaction data comprises information related to one or more remaining elements of non-interest to the customer from among the plurality of elements presented to the customer during the one or more interactions. The method predicts an intention of the customer based on the interaction data and the non-interaction data. The method provides a customized interaction experience to the customer in one or more interaction channels from among the plurality of interaction channels based on the predicted intention of the customer.

### BRIEF DESCRIPTION OF THE FIGURES

FIG. 1 is a block diagram showing an example apparatus, in accordance with an embodiment of the invention;

FIG. 2 depicts a first screenshot of a customer device screen for illustrating an example capturing of interaction data and non-interaction data related to a customer's journey on a web interaction channel, in accordance with an embodiment of the invention;

FIG. 3 depicts a second screenshot of the customer device screen for illustrating an example customization of interaction experience for the customer on the web interaction channel, in accordance with an embodiment of the invention;

FIG. 4 is a diagram depicting an example customer interaction scenario for illustrating a passing of interaction context between two interaction channels, in accordance with an embodiment of the invention;

FIG. 5 is a schematic diagram showing an example representation of a customer journey on an IVR interaction channel, in accordance with an embodiment of the invention; and

FIG. 6 illustrates a flow diagram of an example method for providing a customized interaction experience to a customer, in accordance with an embodiment of the invention.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

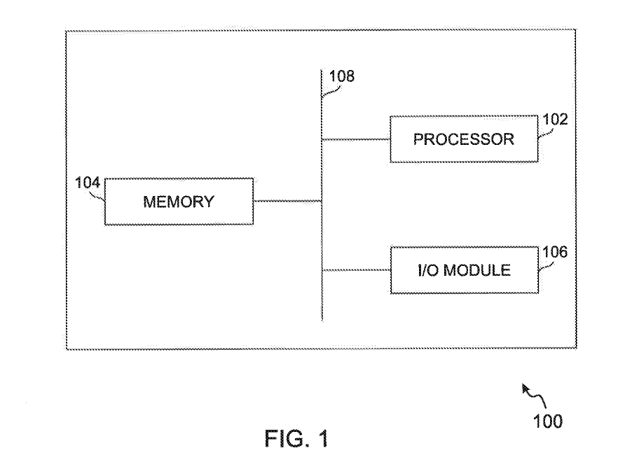

FIG. 1 is a block diagram showing an example apparatus 100, in accordance with an embodiment of the invention. In an embodiment, the apparatus 100 may be deployed in a remote server/machine connected to a communication network (such as a wired network, a wireless network or a combination thereof, such as for example, the Internet) and capable of executing a set of instructions so as to customize interaction experiences of customers. In at least one example embodiment, the apparatus 100 is an electronic system configured to receive data related to customer interactions, to analyze the received data, and to facilitate customization of on-going or subsequent interactions to provide a vastly improved interaction experience to the customers. The term ‘customer’ as mentioned herein and throughout the description refers to an existing or a potential user of products and/or services offered by an enterprise. Moreover, the term ‘interaction’ as mentioned herein and throughout the description may refer to both unidirectional and bi-directional interaction between the customer and the enterprise. For example, a customer browsing a website of an enterprise for locating a desired product is illustrative of a unidirectional interaction between the customer and the enterprise. Similarly, a customer interacting on phone or chatting using a chat application with a customer support representative associated with the enterprise is illustrative of a bi-directional interaction between the customer and the enterprise. It is also noted that the ‘interaction’ may be initiated by the customer or proactively initiated by the enterprise. Further, the interactions may be related to resolving queries of the customer regarding sales or service, for advertising, for containing negative sentiments over social media, for addressing grievances of the customer, for escalation of customer service issues, for enquiring about upgrades, for enquiring about billing or payment or shipping of the product/service, for providing feedback, for requesting feedback, for registering a complaint or to follow up about a previous query and the like.

To collate data corresponding to one or more interactions, in at least one embodiment, the apparatus 100 is configured to be communicably associated with one or more data gathering web servers, such as for example, web servers collating data corresponding to customer activity on one or more websites, or, web servers storing chat transcripts of chat conversations between customers and customer service representatives associated with an enterprise and the like. In at least some embodiments, the apparatus 100 may also be communicably associated with customer touch points, such as mobile phones, tablet devices, personal computers and the like, so as to receive data related to customer interactions from native mobile applications or from speech conversations.

The apparatus 100 includes at least one processor, such as a processor 102 and a memory 104. It is noted that though the apparatus 100 is depicted to include only one processor, the apparatus 100 may include more number of processors therein. In an embodiment, the memory 104 is capable of storing machine executable instructions. Further, the processor 102 is capable of executing the stored machine executable instructions. In an embodiment, the processor 102 may be embodied as a multi-core processor, a single core processor, or a combination of one or more multi-core processors and one or more single core processors. For example, the processor 102 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 102 may be configured to execute hard-coded functionality. In an embodiment, the processor 102 is embodied as an executor of software instructions, wherein the instructions may specifically configure the processor 102 to perform the algorithms and/or operations described herein when the instructions are executed. The processor 102 may include, among other things, a clock, an arithmetic logic unit (ALU) and logic gates configured to support various operations of the processor 102.

The memory 104 may be embodied as one or more volatile memory devices, one or more non-volatile memory devices, and/or a combination of one or more volatile memory devices and non-volatile memory devices. For example, the memory 104 may be embodied as magnetic storage devices (such as hard disk drives, floppy disks, magnetic tapes, etc.), optical magnetic storage devices (e.g. magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

Further, the apparatus 100 includes an input/output module 106 (hereinafter referred to as ‘I/O module 106’) for providing output and/or receiving input. The I/O module 106 is configured to be in communication with the processor 102 and the memory 104. Examples of the I/O module 106 include, but are not limited to, an input interface and/or an output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like. In an example embodiment, the processor 102 may include I/O circuitry configured to control at least some functions of one or more elements of the I/O module 106, such as, for example, a speaker, a microphone, a display, and/or the like. The processor 102 and/or the I/O circuitry may be configured to control one or more functions of the one or more elements of the I/O module 106 through computer program instructions, for example, software and/or firmware, stored on a memory, for example, the memory 104, and/or the like, accessible to the processor 102.

In an embodiment, various components of the apparatus 100, such as the processor 102, the memory 104 and the I/O module 106 are configured to communicate with each other via or through a bus 108. In an embodiment, the bus 108 may be embodied as a centralized circuit system. The centralized circuit system may be various devices configured to, among other things, provide or enable communication between the components (102-106) of the apparatus 100. In certain embodiments, the centralized circuit system may be a central printed circuit board (PCB) such as a motherboard, main board, system board, or logic board. The centralized circuit system may also, or alternatively, include other printed circuit assemblies (PCAs) or communication channel media.

It is understood that the apparatus 100 as illustrated and hereinafter described is merely illustrative of an apparatus that could benefit from embodiments of the invention and, therefore, should not be taken to limit the scope of the invention. It is noted that the apparatus 100 may include fewer or more components than those depicted in FIG. 1. Moreover, the apparatus 100 may be implemented as a centralized apparatus, or, alternatively, the various components of the apparatus 100 may be deployed in a distributed manner while being operatively coupled to each other. In another embodiment, the apparatus 100 may be embodied as a mix of existing open systems, proprietary systems and third party systems. In another embodiment, the apparatus 100 may be implemented completely as a set of software layers on top of existing hardware systems. In an exemplary scenario, the apparatus 100 may be any machine capable of executing a set of instructions (sequential and/or otherwise) so as to provide customized interaction experience to the customers.

It is understood that enterprises and their customers may interact with each other on various interaction channels, such as for example, a web interaction channel, a chat interaction channel, a speech interaction channel, a social media interaction channel, a native mobile interaction channel, an interactive voice response (IVR) interaction channel and an in-person or a physical interaction channel, such as for example, a customer visit to an enterprise store or a retail outlet. In some embodiments, interactions between the enterprises and the customers may be conducted on two or more interaction channels simultaneously. For example, a customer support representative for an enterprise may assist a customer to register on a website on the customer's tablet device by taking him through the various steps involved in the registration process over a phone call. In such a case, the interaction may be simultaneously conducted over the web interaction channel as well as the speech interaction channel. Moreover, in some example embodiments, interactions may be traversed from one interaction channel to another interaction channel.

In at least one example embodiment, a customer may be presented with a plurality of elements to choose from, during an interaction with an enterprise. For example, a website may present elements such as a plurality of content portions, hypertext markup language (HTML) links, drop-down menus, advertisements and the like, to the customer browsing the website. In another example, an IVR menu may be configured to assist customers of an enterprise, for example a banking enterprise, may present a customer with elements like menu options for accessing a banking service or a credit card service, for paying bills, for lodging complaints and the like. In yet another example, during a chat conversation or even a speech conversation, a customer support representative (also referred to hereinafter as an ‘agent’) may present a customer with various choices (for example, promotional offers or discount schemes) to choose from. Accordingly, a customer may be presented with a plurality of elements during the course of an interaction. Some of these elements may be of interest to the customer, whereas one or more remaining elements may be of no interest to the customer.

In at least one example embodiment, the apparatus 100 is caused to determine the elements of interest to the customer based on customer actions on the interaction channel. For example, the customer may select one or more options from among a plurality of options presented to the customer as elements on the interaction channel. In another example, a customer action may be related to a focus event or mouse rollover event indicative of the customer having viewed one or more content portions from among content displayed to the customer. For example, a website may present one or more images, e.g. of products, to the customer and the customer may focus on some of the presented images for say a duration of time greater than a preset threshold (for example, order of few seconds) thereby indicating possible interest. A mouse-rollover or movement of a mouse or a trackball or any such input means on portions of displayed content, whether be it on a website or a native mobile application, may also indicate customer interest. In yet another example, touch input events by a customer on displayed content on touch-enabled electronic devices, such as for example, Smartphones, tablet computers, mobile phones, wearable devices, like smart watches etc., may also be indicative of customer's preferences or interest. Further, implicit or explicit verbal utterances during a speech interaction or an IVR interaction and/or textual input events of a customer during a chat conversation may also be indicative of customers' interest. In at least one embodiment, information related to elements of interest to the customer is referred to herein as interaction data. It is understood that the term ‘information’ related to elements of interest refers to information uniquely identifying those elements of interest as well as any other relevant information related to the elements of interest, such as for example, number of times a HTML link was accessed or a displayed image focused on or a particular word repeated, and the like.

In at least one example embodiment, the apparatus 100 is caused to determine the elements of non-interest to the customer based on at least one of: one or more options not selected or de-selected from among a plurality of options presented to the customer; one or more content portions not viewed from among content displayed to the customer; touch event options ignored or skipped by the customer; non-affirmative verbal utterances from the customer; textual input events indicative of customer's non-interest in the one or more remaining elements presented to the customer during the one or more interactions and the like. In at least one embodiment, information related to elements of non-interest to the customer is referred to herein as ‘non-interaction data’. It is understood that the term ‘information’ related to elements of non-interest refers to information uniquely identifying those elements of non-interest as well as any other relevant information related to the elements of non-interest, such as for example, number of webpage exit-events, routine rejection of a particular offer, negative sentiment associated with a particular element, and the like.

In an embodiment, the processor 102 is configured to, with the content of the memory 104, cause the apparatus 100 to facilitate capturing of the interaction data and the non-interaction data related to one or more interactions of a customer. For example, a customer may access one or more websites during a web browsing session and the apparatus 100 may be caused to capture information related to a customer's journey on those multiple websites. It is noted that the term ‘journey’ as mentioned herein and throughout the description refers to a path a customer may take to reach his/her goal when using a particular interaction channel, such as a website, a native mobile application, an IVR system, a chat/voice session with a customer service agent, and the like. For example, web journey (or a journey on a website) may include a number of web page visits and decision points that carry the customer from one step to another step. In another illustrative example, an IVR journey may refer to a sequential path followed while accessing an IVR system. In an embodiment, the captured information related to the interaction data and the non-interaction data may include, but is not limited to, user-clicks, mouse movements, hypertext mark-up language (HTML) links those which are clicked and those which are not clicked, focus events (for example, events during which the customer has focused on a link for a more than a predetermined amount of time), non-focus events (for example, choices the customer did not make from information presented to the customer (for examples, products not selected) or non-viewed content derived from scroll history of the customer), touch events (for example, events involving a touch gesture on a touch-sensitive device such as a tablet), non-touch events (for example, events involving no-touch gesture on a touch-sensitive device such as a tablet), textual words or verbal utterances, or intentions described, or intentions inferred during interaction between the customer and the agent and the like. More specifically, the captured information related to the customer's journey on the interaction channel may include both customer interaction events as well as customer non-interaction events, i.e. both the interaction data and the non-interaction data, respectively.

In at least one example embodiment, the apparatus 100 is caused to detect a presence of a customer in one or more interaction channels from among the plurality of interaction channels. The determination of the presence of the customer in one or more interaction channels may be performed as explained below:

In an embodiment, the apparatus 100 may be configured to actively probe a presence of the customer in any of the interaction channels. For example, the apparatus 100 may be caused to track invoking of native mobile applications corresponding to a chosen product/service in electronic devices corresponding to the customers. Upon identifying an instance of invoking of a native mobile application in an electronic device associated with a customer, the apparatus 100 may be caused to determine the presence of the customer in the native mobile application interaction channel. In another illustrative example, if the apparatus 100 identifies an instance of a customer browsing a website corresponding to the selected product/service, then the apparatus 100 may be caused to determine the presence of the customer in the web interaction channel. In yet another illustrative example, the customer may have logged in to one or more social networking media accounts or public interaction/sharing accounts, such as for example, in any of Facebook®, Twitter™, LinkedIn™ and the like. The apparatus 100 may accordingly record the presence of the customer in social interaction channel. In still another illustrative example, the customer may be chatting on a chat application. The apparatus 100 may detect the presence of the customer in the messaging channel and record the presence accordingly. In an embodiment, one or more tracking cookies may be configured to be included in a device browser associated with the customer device, which may enable the apparatus 100 to identify the presence of the customer in an interaction channel. It is understood that determining presence of the customer in an interaction channel may be performed by the apparatus 100 based on stored data corresponding to the customer, such as for example, customer's personal details like name, mailing address, contact information such as mobile phone number, login id, IP address and the like. Accordingly, an instance of invoking a native mobile application in a mobile phone may result in determination of the customer associated with the corresponding mobile phone number to be present in the native mobile application interaction channel. In another illustrative example, an instance of browsing of a website corresponding to the product/service may result in determination of the customer associated with the corresponding login information/IP address to be present in the web interaction channel.

In at least one example embodiment, the apparatus 100 is caused to establish a browser-level or a tab-level socket connection for facilitating capturing of the interaction data and the non-interaction data related to the one or more interactions of the customer on the web interaction channel. For example, upon detecting presence of the customer in the web interaction channel, the apparatus 100 may be caused to open a socket connection with a server, for example a data-logging server, for every unique user web-browsing session. In an embodiment, a socket connection can be defined as one end-point of a two-way communication link between two programs running on a network. The client application (like the browser application) can talk to the server by writing to the socket connection and receive information from the server by reading from the socket connection. In another example embodiment, the apparatus 100 is caused to track tagged content associated with one or more websites visited by the customer during the customer's interactions on the web interaction channel for facilitating capturing of the interaction data and the non-interaction data. More specifically, the apparatus 100 may be caused to capture the information related to a customer's journey on the web interaction channel based on tags, for example, Java Script tags or HTML tags associated with the one or more websites. It is understood that the tagged websites include those websites that are tagged by the apparatus 100 or those that are recognized as tagged websites by the apparatus 100. For multiple websites, the apparatus 100 may be caused to determine crawl-over document object model (dom) structure to identify links and capture mouse movements. The apparatus 100 may be further caused to sample mouse co-ordinates during the movement at a medium latency interval which can then be mapped back to links, the amount of time spent on the links, and number of times that particular link was visited and the like. Further, as explained above, the apparatus 100 may be caused to capture information related to choices the customer did not make from information presented to the customer (for examples, products not selected), filters selected on user widgets, choices deselected by the customer, non-viewed content derived from scroll history of the customer and the like. In an example embodiment, the memory 104 is caused to store the captured information related to a customer's journey, i.e. interaction and non-interaction data, on the interaction channel.

The determination of the interaction data and the non-interaction data is further explained with reference to following illustrative examples:

In an illustrative example, the customer may access a website with an intention of buying apparel. While browsing the website, i.e. during the customer's web journey, the customer may access displayed image content related to T-shirts and pair of jeans. The same website may also display image content related to other products to the customer, which the customer may choose to ignore. For example, the website may provide content related to footwear, sunglasses, innerwear and the like. However, because the customer did not intend to buy such other products, the customer may choose to ignore the content related to the other products, and may focus only on content related to apparel by, for example, clicking on the images and/or moving mouse cursor over the associated links, and/or performing any such customer actions. The information related to the content accessed as well as the content not accessed by the customer during the customer's journey on the web interaction channel may be captured (for example, using browser-level socket connections or Java Script/HTML tags as explained above). Accordingly, the apparatus 100 may be caused to determine the interaction data as the content accessed by the customer, for example, the content associated with the apparel. Moreover, the apparatus 100 may be caused to determine non-interaction data as the content associated with the other objects that the customer has not selected or, more specifically, chosen to ignore, such as those related to footwear, sunglasses, innerwear and the like.

In another illustrative example, the customer may interact with an IVR system for seeking answers related to a customer concern. While interacting with the IVR system, i.e. during the customer's IVR journey, the customer may be asked a plurality of questions, each of which may include multiple options as answers. The apparatus 100 may be caused to capture information related to the options selected by the customer along with the options not selected by the customer during the customer's journey on the IVR medium. In an example embodiment, natural language utterances during a call with a customer support representative, such as the IVR system may be converted from a speech format to a text format, and the text can be mined to determine a path the customer has chosen along with one or more possible paths that the customer has not selected/chosen to follow. The path configured by the options selected by the customer may be determined as the interaction data by the apparatus 100. The one or more paths configured by options not selected by the customer may then be determined as the non-interaction data by the apparatus 100.

In yet another illustrative example, the customer may interact with an agent over a chat medium. During the chat session, the agent may ask questions from a predetermined set of questions to the customer. In an example embodiment, the questions asked by the agent and the responses provided by the customer may facilitate in determining an interaction data associated with the chat session. In an example embodiment, those questions from among the predetermined set of questions that are not asked by the agent and/or those questions the responses for which are given as non-affirmative by the customer may facilitate in determining a non-interaction data associated with the chat session. In an embodiment, the apparatus 100 may be caused to store the interaction data and the non-interaction data (collectively referred to as customer data) in a textual form to facilitate text based mining therefrom. The apparatus 100 is further caused to store the customer data in the memory 104.

In an embodiment, the processor 102 is configured to, with the content of the memory 104, cause the apparatus 100 to predict an intention of the customer based on the interaction data and the non-interaction data. More specifically, customer data stored in the memory 104 may be subjected to a set of structured and un-structured data analytics including text mining & predictive models (collectively referred to herein as prediction models) for mining relevant information that drive prediction of a customer's intention. Examples of the prediction models may include, but are not limited to algorithmic models based on logistic regression, naïve Bayesian, rule engines, neural networks, decision trees, support vector machines, k-nearest neighbor, k-means clustering, hierarchical clustering, and the like. The prediction models may be configured to extract certain features from the customer data. Examples of the features that may be fed into the prediction models may include, but are not limited to, any combinations of words features such as unigrams, bigrams, trigrams, n-grams, word phrases, part-of-speech of words, sentiment of words, sentiment of sentences, position of words, customer keyword searches, customer click data, customer web journeys, cross-channel journeys, call-flow, the customer interaction and non-interaction history across multiple channels of interaction and the like. In an embodiment, the prediction models may utilize any combination of the above-mentioned input features along with the interaction data such as, but not limited to, which component (web-browser, agent, IVR and/or digital self-service system) handled the interaction, what the outcome was, interaction transfers if any and the like to predict the customer's likely intentions.

In an embodiment, the processor 102 is configured to, with the content of the memory 104, cause the apparatus 100 to provide a customized interaction experience to the customer in one or more interaction channels based on the predicted intention of the customer. In at least one example embodiment, the customized interaction experience is provided to the customer during an on-going interaction itself or in a subsequent customer interaction on the one or more interaction channels. For example, the apparatus 100 may be caused to display a customer-intention specific version of a website to the customer upon subsequent access of the website by the customer. In an embodiment, displaying the customer-intention specific version of the website to the customer may include displaying one or more portions of website content relevant to the predicted intention of the customer substantially more prominently than one or more remaining portions of the website content. In another embodiment, a presentation of content during a subsequent web browsing session may involve displaying content corresponding to the interaction data more prominently, whereas the content corresponding to the non-interaction data is displayed relatively less prominently. It is understood that a prominent display of content on a web page may imply displaying the content in the most optimized manner to enable easy viewing experience to the customer. The content may accordingly be appropriately placed (for example, right side top corner) or highlighted or associated with increased size or catchy colors to attract the customer's attention.

In other illustrative example, when a customer, who has previously intended to pay a credit card bill by calling a concerned banking number over an IVR system, contacts the IVR system again, then the apparatus 100 may be caused to present options based on the path previously chosen by the customer. It is noted that based on the determination of the non-interaction data, the apparatus 100 may be caused to not initially present the customer with any of the other possible options that the customer has not accessed during the previous call. In another illustrative example, if a customer has been browsing content related to footwear on a website and subsequently opts for a voice call based interaction, then the agent may avoid an initial probing question of seeking to understand customer's intention and provide information related to promotional offers or discounts on footwear.

In another illustrative example, if a customer opts for a chat interaction during a web browsing session, then the predicted intention on the website may be used to customize the chat experience. For example, the predicted intent may enable an agent to avoid an initial probing question to the customer thereby reducing the overall handle time of the chat interaction. Accordingly, the interaction and non-interaction history collected over multiple mediums of interactions may be used to predict intention of the customer and customize channel experience across interaction channels.

In an embodiment, the apparatus 100 is caused to pass an interaction context related to the customer interactions among two or more interaction channels to facilitate prediction of the intention based on interaction history across multiple interaction channels. For example, the apparatus 100 may be caused to create, capture, and/or pass unique identifiers between multiple interaction channels, such as web, mobile, IVR, phone and the like, to identify and tag the customer and their context, e.g. history, past behavior, steps progressed, obstacles and/or issues encountered, etc., uniquely. In an embodiment, the unique identifiers may be used to create linkages across channels and devices within the same session, as well as across sessions probabilistically based on machine learning and statistical models driven by behavior and other attributes of customer journeys. Examples of various unique identifiers may include, but are not limited to IP address, user-agent, Web cookies, third party Web cookies, order IDs, request IDs, various personally identifiable information (PII), mobile device identifiers, and the like. The creating, passing, and matching of unique identifiers to unique customers enables the seamless transfer of context, experience, history, action, interaction information, and authentication information between separate interaction channels that customers typically use to engage with enterprises and/or businesses.

In at least one embodiment, the apparatus 100 may be caused to facilitate or establish a tie between interaction channels allowing for communication via one interaction channel to be augmented or transferred to another interaction channel that may be more optimal. The alternative interaction channel may contain a different channel of communication. For example, verbal communication in an IVR system can be augmented with pertinent graphical images presented through a Web browser in a coincident Web session. For example, if it is determined that the customer can be better served by using other interaction channels than that with which the customer is concurrently interacting, then the apparatus 100 is caused to offer integrated services to the customer by using both the current interaction channels and the other interaction channels, or the apparatus 100 is caused to divert the customer to the other interaction channel from the interaction channel with which customer is concurrently interacting. If the customer is interacting on two interaction channels at once, the apparatus 100 is caused to use multi-channel data to coordinate the experience across the two or more interaction channels. For example, if a product shopper still has a web page open when he makes the call to the IVR system, the IVR system can offer a deal on a particular product model and simultaneously push the web browser to the web page for that product. This is possible because the IVR phone call is from a phone number that is associated with the HTTP cookie for that web browser.

In an illustrative example, the apparatus 100 is caused to supplement or divert a customer call to a linked web session. The linked web session may be established by forwarding the corresponding web links or content to the customer via SMS or email, by asking and/or instructing the customer to visit a personalized web page, by opening a preconfigured web page whenever the customer calls a predefined number, by a registered customer device initiating a linked session in response to the request from a customer support representative, or by the customer initiating a session on the customer's device and linking the session.

In an embodiment, the web sessions may be automated as well as agent-guided, web sessions. In an embodiment, the apparatus 100 may be caused to authenticate the customer during addition of an interaction channel or where customer is interacting via a device, which can be utilized by other customers. For example, consider a phone call interaction that contains customer authentication. When a mobile web experience is added to this existing phone call, authentication may be achieved by virtue of the phone call continuing along with the web interaction. Further, for security reasons the mobile web experience may last only for the duration of the call. In some embodiments, where the web experience is on a different device than the phone, for example desktop or laptop, authentication may be achieved by sending email with a microsite uniform resource locator (URL) to the registered email account for the customer. Alternatively, a unique URL may be provided to the customer on the phone call, which may last only for the duration of the phone call. It is understood that other modes of authentication such as bio-metric data, facial/speech recognition and the like may also be utilized for facilitating such linked interaction sessions.

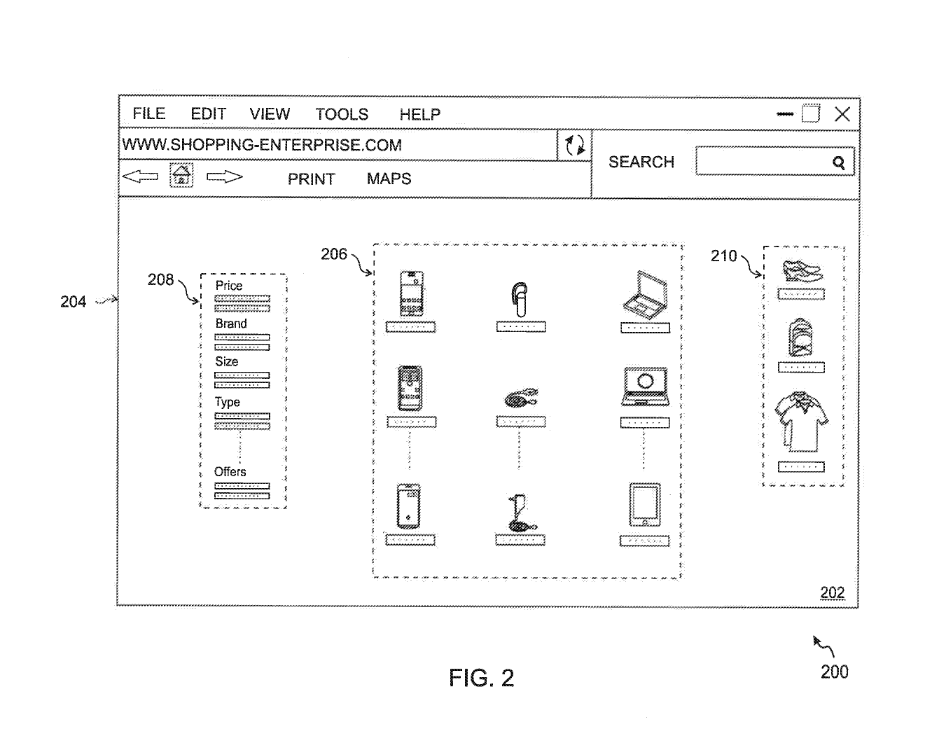

In an embodiment, the apparatus 100 is caused to predict the most appropriate method of customization based on data driven approaches such as, modeling or performing design of experiments. Some examples of such methods of customization may include but are not limited to routing a chat conversation to an agent with the best matching personality type, deflecting an interaction to a different interaction channel and/or agent, sending a self serve link, sharing a knowledge base article, providing resolution to customer query over an appropriate interaction channel, escalation or suggestion of escalation of customer service level, offering a discount to the customer, recommending products to the customer for up-sell/cross-sell, suggesting products to up-sell/cross-sell to the agent as a recommendation, offering a suggestion for a discount to the agent as a recommendation, recommending a style of conversation to the agent during an interaction, presenting a different set of productivity or visual widgets to the agent to facilitate personalization of interaction with specific persona types on the agent interaction platform, presenting a different set of productivity or visual widgets to the customers with specific persona types on the customer interaction platform, proactive interaction, customizing the speed of interaction, customizing the speed of servicing information and the like. The customization of interaction experience is further explained with reference to FIGS. 2, 3, 4 and 5.

Referring now to FIG. 2, a first screenshot of a customer device screen 200 is depicted for illustrating an example capturing of the interaction data and the non-interaction data related to a customer's journey on a web interaction channel, in accordance with an embodiment of the invention. The customer device screen 200 may be a part of an electronic device, such as for example a mobile phone, a Smartphone, a tablet device, a laptop computer, a personal computer, a personal digital assistant, a wearable device or the like. The customer device screen 200 depicts a web page 202 corresponding to an URL ‘WWW.SHOPPING-ENTERPRISE.COM’ being displayed in a web browser 204 associated with the electronic device corresponding to the customer device screen 200. Examples of the web browser 204 may include, but are not limited to popular web browsers, such as Internet Explorer® web browser, Safari® web browser, Chrome™ web browser and Mozilla® web browser or even proprietary web browsers. The web browser 204 is depicted to display standard menu options which are not explained herein for sake of brevity.

In an example embodiment, the apparatus 100 explained with reference to FIG. 1, may be communicably associated with a web server hosting the website corresponding to the URL ‘WWW.SHOPPING-ENTERPRISE.COM’. Further, the apparatus 100 is configured to capture information related to a customer's journey on the website. As explained with reference to FIG. 1, the apparatus 100 is caused to capture information related to user-clicks, mouse movements, HTML links, focus events, non-focus events, touch events, non-touch events and the like. Further, as explained with reference to FIG. 1, the apparatus 100 may be configured to capture information related to a customer's journey on the web interaction channel using a browser-level socket connection or using Java Script tags. During the customer's web journey, the customer's activity may involve multiple clicks, mouse roll-overs and even visits to related web pages from the same or other websites.

The web page 202 is configured to display a products display section 206 including a listing of images related to products, such as mobile phones, phone accessories (like Bluetooth headsets, adapters, phone charging cables and the like) and other electronic gadgets (like laptops, tablets and the like). The web page 202 is also configured to display a products filter section 208 including filtering options (like those based on, price range, brand, size, type of product and the like). Additionally, the web page 202 is also configured to display an advertisements section 210 including image content related to apparel and footwear. It is understood that the various sections of the web page 202, such as the products display section 206, the products filter section 208 and the advertisements section 210 is depicted herein for illustration purposes and should not be considered to be limiting the scope of the present technology.

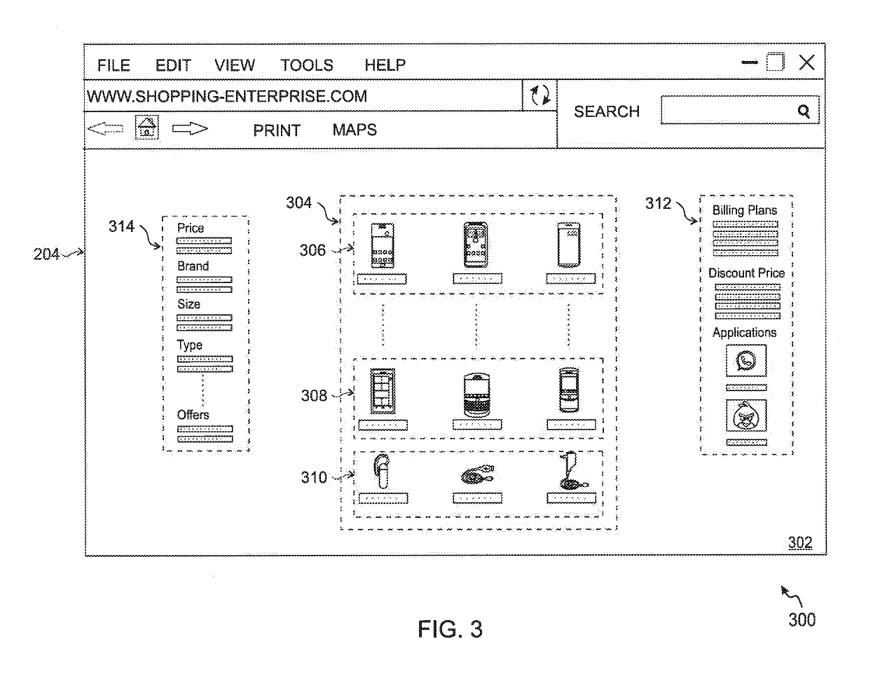

In an example scenario, a customer's web journey on the website may include selection of mobile phones from among the products displayed in the products display section 206. The apparatus 100 may be caused to capture the customer activity, such as for example, accessing of images related to mobile phones. The customer's journey on the web page 202 may also include a brief focus event (or a mouse roll over event) on accessories related to mobile phones. Accordingly, from the captured customer activity, the apparatus 100 may be caused to determine the interaction data as content related to (1) mobile phones and (2) accessories related to mobile phones. The apparatus 100 may further determine the non-interaction data as content related to images/sections not accessed by the customer during the customer's web journey on the web page 202. For example, content related to other electronic devices (like laptops, tablet devices), apparel and footwear and the like may be determined as non-interaction data by the apparatus 100. In an example embodiment, a customer's selection (or non-selection) of filtering options displayed in the products filter section 208 may also be captured and interaction/non-interaction data determined based on the captured information. The captured interaction data and non-interaction data may be stored in the memory 104 as customer data and subjected to prediction models as explained with reference to FIG. 1. Upon prediction of the customer's intention using the prediction models, it may be determined that the customer intends to buy an Android based mobile phone. It may further be inferred that the customer has additional budget to purchase an accessory related to the Android based mobile phone. Accordingly, the apparatus 100 is configured to present information, during a subsequent web browsing session, in a manner that content corresponding to the interaction data is displayed more prominently, whereas the content corresponding to the non-interaction data is displayed relatively less prominently. Such a presentation of content is displayed in FIG. 3.

Referring now to FIG. 3, a second screenshot of a customer device screen 300 is depicted for illustrating an example customization of interaction experience for the customer on the web interaction channel, in accordance with an embodiment of the invention. More specifically, the second screenshot 300 depicts a web page 302 (or more specifically, the web page 202 with modified content). As explained with reference to FIG. 1, the apparatus 100 is configured to present a customer intention specific version of the website to the customer during an on-going web browsing session or a subsequent web browsing session. To that effect, content corresponding to the predicted intention is displayed more prominently, whereas the content corresponding to the non-interaction data is displayed relatively less prominently. Further, as explained with reference to FIG. 2, the apparatus 100 may determine that the customer intends to buy an Android based mobile phone and further have budget to purchase an accessory related to the Android based mobile phone. Accordingly, the web page 302 may display a modified products display section 304 including a prominent listing of Android based mobile phones as depicted in row 306. A placement, size of the images, colors may be accordingly configured to ensure maximum attention of the customer. In an example embodiment, only a placement of the content related to the predicted intention may be managed to ensure optimum customer attention, whereas a size and color of the image content may be retained as-is. For example, image content related to Android based mobile phones may be placed in the top few rows with listing of image content related to other operating system based mobile phones in lower rows. The products display section 304 may also display listing of other mobile phones (such as for example, iOS based mobile phones or Windows based mobile phones) relatively less prominently as depicted in row 308. The products display section 304 may also display accessories specific to Android based mobile phones as depicted in row 310. Further, the advertisements display section 312 may be configured to depict products/services related to Android based mobile phones, such as for example billing plans, popular Android applications and the like. The products filter section 314 may be retained as depicted in FIG. 2 (for example, products filter section 208) or may be customized to reflect Android based preferences, such as Android based mobile phone manufacturers and price ranges based on their corresponding products and/or price band selected by the customer during a previous web browsing session. A provisioning of a such a customized website (as exemplarily depicted by web page 302) to a customer improves an overall interaction experience of the customer as the desired information is readily displayed and the customer has to spend far less effort in identifying and selecting desired products/services.

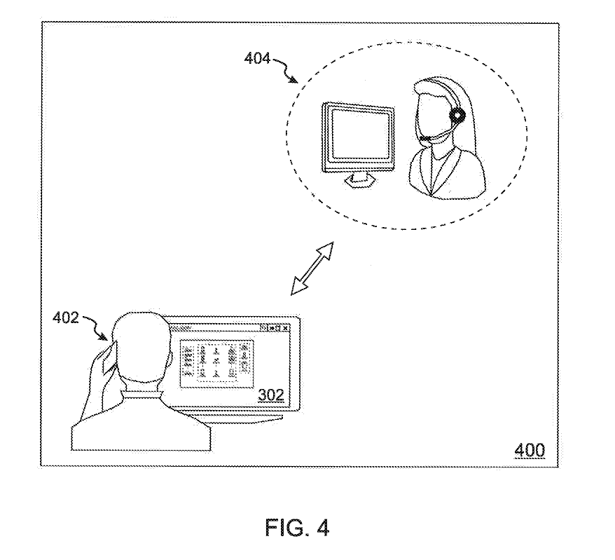

As explained with reference to FIG. 1, the apparatus 100 is caused to pass an interaction context related to the customer interactions among two or more interaction channels to facilitate prediction of the intention based on interaction history across multiple interaction channels. The passing of the interaction context for facilitating prediction of the intention based on interaction history across multiple interaction channels is further explained with reference to FIG. 4.

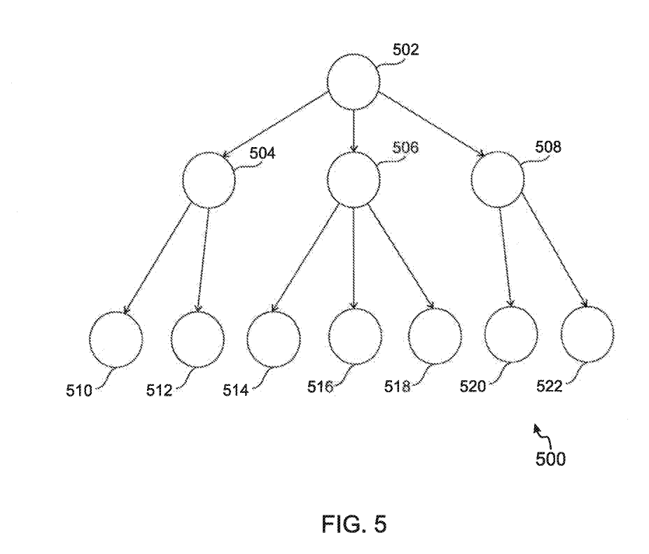

Referring now to FIG. 4, a diagram 400 depicting an example customer interaction scenario is shown for illustrating a passing of interaction context between two interaction channels, in accordance with an embodiment of the invention. Accordingly, the diagram 400 depicts a customer 402 is depicted to have called an agent 404 associated with a cellular service provider for requesting information related to a billing plan subsequent to customer's journey on the web interaction channel as explained with reference to FIG. 3. Since the customer has purchased an Android based phone on the web interaction channel, this interaction context may be passed on to the agent 404 handling the customer call by the apparatus 100. The passing of interaction context may be performed using unique identifiers as explained in detail with reference to FIG. 1. Based on the interaction context, the apparatus 100 may be caused to predict an intention of the customer 402 to purchase a data plan for his/her Android phone. This predicted intention may then be utilized to customize the customer's interaction experience on the speech interaction channel. Accordingly, the agent 404 may suggest data plans for cellular providers like AT&T, Sprint, T-mobile or Verizon which are most suitable to the brand of Android phone purchased by the customer 402. Additionally, the agent 404 may also provide information related to promotional offers or monthly installment schemes that the customer 402 may likely be interested in. Similarly, if the customer 402 opts for a chat interaction subsequent to customer's journey on a web interaction channel, then the predicted intention related to customer's preference for services related to Android based mobile phones may be utilized to customize the chat interaction experience. Another example for illustrating a provisioning of customized interaction experience is explained with reference to FIG. 5.

FIG. 5 is a schematic diagram showing an example representation 500 of a customer journey on an IVR interaction channel, in accordance with an embodiment of the invention. As explained with reference to FIG. 1, the apparatus 100 may be caused to determine the interaction data and the non-interaction data based on captured information related to the customer's journey on the IVR interaction channel. More specifically, while interacting with the IVR system (i.e. during the customer's IVR journey), the customer may be asked a plurality of questions, each of which may include multiple options as answers. The path configured by the options selected by the customer may be determined as the interaction data. The one or more paths configured by options not selected by the customer may be determined as the non-interaction data.

In an embodiment, if each stage of a customer's IVR journey is represented by a node, then the customer's IVR journey including a plurality of stages may configure a tree structure including a plurality of nodes. The example representation 500 depicts such a tree structure representation (also referred to herein as tree structure). The customer's IVR journey may be initiated at node 502 at which a plurality of options may be offered to a customer. Based on the option selected by the customer, a branch of tree structure along one of the nodes 504, 506 and 508 may be traversed. Each node from among the nodes 504, 506 and 508 may be associated with a number of options to be offered to the customer. Based on the customer's choice the branch of the tree structure along one of nodes 510, 512, 514, 516, 518, 520 and 522 may be traversed. The customer's journey on the IVR system is further explained with reference to an illustrative example, where the IVR system corresponds to customer assistance interface for a telecom service. At node 502, the customer may be provisioned with a welcome message along with options for receiving assistance for queries related to (1) tariff plans, (2) bill payment and (3) consumer complaints. If the customer chooses to the receive assistance for queries related to tariff plans, then the customer may be directed to node 504. At node 504, the customer may be offered options for receiving assistance for queries related to: (1) mobile service related tariffs and (2) mobile and data service related tariffs. If the customer chooses to the receive assistance for queries related to mobile service related tariffs then the customer may be directed to node 510. If the customer chooses to the receive assistance for queries related to mobile and data service related tariffs then the customer may be directed to node 512. At the nodes 510 and 512, tariff plans related to mobile service and mobile plus data service may be explained and an option to choose one option from among a plurality of options may be offered to the customer.

Similarly, if the customer chooses to the receive assistance for paying bills at node 502, then the customer may be directed to the node 506. At the node 506, the customer may be offered options for receiving assistance for making payment through: (1) Internet banking; (2) debit card and (3) credit card. If the customer chooses to receive the assistance for internet banking based payment, for debit card based payment or for credit card based payment, then the customer may be directed to the node 514, 516 or 518, respectively. At the nodes 514, 516 and 518, bill payment based on chosen mode of payment may be facilitated. Similarly, if the customer chooses to receive the assistance for their corresponding complaints at the node 502, then the customer may be directed to the node 508. At the node 508, the customer may be offered options for receiving assistance for (1) billing related disputes and (2) network connectivity related issues. If the customer chooses to receive the assistance for billing related disputes or for network connectivity related issues then the customer may be directed to the node 520 or 522, respectively. At the nodes 520 and 522, dispute resolution based on requested mode of assistance may be facilitated.

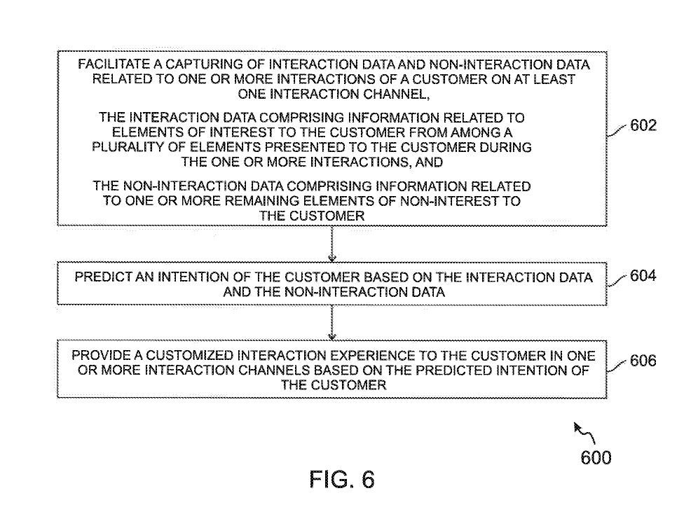

In an example scenario, the customer's journey on the IVR system explained above may follow the sequence of options associated with the nodes 502, 506 and 518. Accordingly, the path associated with options selected by the customer during the customers' IVR journey may be stored as interaction data, whereas other paths not selected by the customer, such as for example the path associated with sequence of options corresponding to the nodes 502, 504 and 510 and the like, may be determined as non-interaction data by the apparatus 100. Combined with information, such as the current date information, a bill payment cycle of the customer may be recognized. If the customer subsequently calls the IVR system at a date corresponding to bill payment cycle date, the apparatus 100 may be caused to offer only the path configured by a sequence of options associated with the nodes 502, 506 and 518. For example, at the node 502, the customer may be asked if the customer wants to pay bill using his/her credit card, thereby providing a customized interaction experience to the customer. If the customer wishes to choose any other option, then the customer may be offered choices like those related to tariff plans and disputes as explained above. A method for providing customized interaction experience is explained with reference to FIG. 6.

FIG. 6 illustrates a flow diagram of an example method 600 for providing a customized interaction experience to a customer, in accordance with an embodiment of the invention. The method 600 depicted in the flow diagram may be executed by, for example, the apparatus 100 explained with reference to FIGS. 1 to 5. Operations of the flowchart, and combinations of operation in the flowchart, may be implemented by, for example, hardware, firmware, a processor, circuitry and/or a different device associated with the execution of software that includes one or more computer program instructions. The operations of the method 600 are described herein with help of the apparatus 100. For example, one or more operations corresponding to the method 600 are explained herein to be executed by a processor, such as the processor 102 of the apparatus 100. It is noted that though the one or more operations are explained herein to be executed by the processor alone, it is understood that the processor is associated with a memory, such as the memory 104 of the apparatus 100, which is configured to store machine executable instructions for facilitating the execution of the one or more operations. It is also noted that, the operations of the method 600 can be described and/or practiced by using an apparatus other than the apparatus 100. The method 600 starts at operation 602.

At operation 602, the method 600 includes facilitating a capturing of interaction data and non-interaction data related to one or more interactions of a customer on at least one interaction channel from among a plurality of interaction channels. It is understood that enterprises and their customers may interact with each other on various interaction channels, such as for example, a web interaction channel, a chat interaction channel, a speech interaction channel, a social media interaction channel, a native mobile interaction channel, an interactive voice response (IVR) interaction channel and an in-person or a physical interaction channel, such as for example, a customer visit to an enterprise store or a retail outlet. In an embodiment, the captured information may include customer interaction data and non-interaction data such as, but not limited to, user-clicks, mouse movements, hypertext mark-up language (HTML) links those which are clicked and those which are not clicked, focus events (for example, events during which the customer has focused on a link for a more than a predetermined amount of time), non-focus events (for example, choices the customer did not make from information presented to the customer (for examples, products not selected) or non-viewed content derived from scroll history of the customer), touch events (for example, events involving a touch gesture on a touch-sensitive device such as a tablet), non-touch events (for example, events involving no-touch gesture on a touch-sensitive device such as a tablet), textual words or verbal utterances, or intentions described, or intentions inferred during interaction between the customer and the agent, and the like. As explained with reference to FIG. 1, the interaction data corresponds to information related to elements of interest to the customer from among a plurality of elements presented to the customer during the one or more interactions, whereas, the non-interaction data corresponds to information related to one or more remaining elements of non-interest to the customer from among the plurality of elements presented to the customer during the one or more interactions. In an illustrative example, the information related to a customer's journey on a web interaction channel may be captured using one of browser-level socket connection and Java Script tags as explained with reference to FIG. 1.

At operation 604, the method 600 includes predicting an intention of the customer based on the interaction data and the non-interaction data. More specifically, customer data stored in the memory 104 may be subjected to a set of structured and un-structured data analytics including text mining & predictive models for mining relevant information that drive prediction of a customer's intention. Examples of prediction models are provided with reference to FIG. 1 and are not included again herein.

At operation 606, the method 600 includes providing a customized interaction experience to the customer in one or more interaction channels from among the plurality of interaction channels based on the predicted intention of the customer. In at least one example embodiment, the customized interaction experience is provided to the customer during an on-going interaction itself or in a subsequent customer interaction on the one or more interaction channels. For example, a customer-intention specific version of a website may be displayed to the customer upon subsequent access of the website by the customer. In an embodiment, displaying the customer-intention specific version of the website to the customer may include displaying one or more portions of website content relevant to the predicted intention of the customer substantially more prominently than one or more remaining portions of the website content as explained with reference to FIG. 3.

Some other examples of such methods of customization may include but are not limited to routing a chat conversation to an agent with the best matching personality type, deflecting an interaction to a different interaction channel and/or agent, sending a self serve link, sharing a knowledge base article, providing resolution to customer query over an appropriate interaction channel, escalation or suggestion of escalation of customer service level, offering a discount to the customer, recommending products to the customer for up-sell/cross-sell, suggesting products to up-sell/cross-sell to the agent as a recommendation, offering a suggestion for a discount to the agent as a recommendation, recommending a style of conversation to the agent during an interaction, presenting a different set of productivity or visual widgets to the agent to facilitate personalization of interaction with specific persona types on the agent interaction platform, presenting a different set of productivity or visual widgets to the customers with specific persona types on the customer interaction platform, proactive interaction, customizing the speed of interaction, customizing the speed of servicing information and the like.

In an embodiment, an interaction context related to the customer interactions may be passed among two or more interaction channels to facilitate prediction of the intention based on interaction history across multiple interaction channels. The passing of interaction context may be performed as explained with reference to FIGS. 1 and 4 and are not explained again, herein.

Without in any way limiting the scope, interpretation, or application of the claims appearing below, advantages of one or more of the exemplary embodiments disclosed herein include providing customized interaction experience to the customers. Various embodiments disclosed herein provide numerous advantages for enhancing a customer service experience, thereby contributing to increased attributable revenue, increased resolution rates, increased efficiency, decreased cost of service and cost of sales, increased loyalty and retention, deepened relationship and increased life time value. The techniques disclosed herein suggest the determination of the non-interaction data in addition to the interaction data, which enables in better understanding of customer's preferences during a customer's journey on an interaction channel. More specifically, capturing information related to ‘what a user is not interested in’, in addition to, ‘what the user is interested in’, enables in better understanding of customer's preferences during a journey on an interaction channel. In various scenarios, a large amount of interaction data is typically required for facilitating a fairly accurate intention prediction, which is a time-consuming process. The capturing of the interaction and non-interaction data collected over multiple interaction channels can help achieve higher granularity of prediction of customer intention and help make faster recommendations to the customer in real-time resulting in a higher possibility of conversions, for example a sale of a product. Accordingly, the determination of non-interaction data in addition to the interaction data facilitates a fairly accurate intention prediction in a time-efficient manner. Further, such a manner of data collation and intention prediction enhances accuracy of personalization of websites and/or customer service calls and/or chats for different customers. For example, the techniques disclosed herein facilitates in presenting different versions of the same website to different customers, thereby enabling a unique user experience for each customer as explained with reference to FIGS. 1 and 5.

Although the present technology has been described with reference to specific exemplary embodiments, it is noted that various modifications and changes may be made to these embodiments without departing from the broad spirit and scope of the present technology. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the apparatus 100, the processor 102 and the memory 104 may be enabled using software and/or using transistors, logic gates, and electrical circuits (for example, integrated circuit circuitry such as ASIC circuitry). Various embodiments of the present technology may include one or more computer programs stored or otherwise embodied on a computer-readable medium, wherein the computer programs are configured to cause a processor or computer to perform one or more operations (for example, operations explained herein with reference to FIG. 6). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (Blu-ray (registered trademark) Disc), and semiconductor memories (such as mask ROM, PROM (programmable ROM), EPROM (erasable PROM), flash ROM, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the present disclosure, as discussed above, may be practiced with steps and/or operations in a different order, and/or with hardware elements in configurations which are different than those which are disclosed. Therefore, although the technology has been described based upon these exemplary embodiments, it is noted that certain modifications, variations, and alternative constructions may be apparent and well within the spirit and scope of the technology.

Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
facilitating, by a processor, a capturing of interaction data and non-interaction data related to one or more interactions of a customer on at least one interaction channel from among a plurality of interaction channels, the interaction data comprising information related to elements of interest to the customer from among a plurality of elements presented to the customer during the one or more interactions, the non-interaction data comprising information related to one or more remaining elements of non-interest to the customer from among the plurality of elements presented to the customer during the one or more interactions;
predicting, by the processor, an intention of the customer based on the interaction data and the non-interaction data; and
providing, by the processor, a customized interaction experience to the customer in one or more interaction channels from among the plurality of interaction channels based on the predicted intention of the customer.

2. The method of claim 1, further comprising:
determining the elements of interest to the customer based on customer actions related to at least one of:
selection of one or more options from among a plurality of options presented to the customer;
focus events or mouse rollover events indicative of the customer having viewed one or more content portions from among content displayed to the customer;
touch input events indicative of customer's preferences; and
at least one of verbal utterances and textual input events indicative of customers' interest.

3. The method of claim 1, further comprising:
determining the elements of non-interest to the customer based on at least one of:
one or more options not selected or de-selected from among a plurality of options presented to the customer;
one or more content portions not viewed from among content displayed to the customer;
touch event options ignored or skipped by the customer;
non-affirmative verbal utterances from the customer; and
textual input events indicative of customer's non-interest in the one or more remaining elements presented to the customer during the one or more interactions.

4. The method of claim 1, wherein an interaction channel from among the plurality of interaction channels corresponds to one of a web interaction channel, a chat interaction channel, a speech interaction channel, a social media interaction channel, a native mobile interaction channel, an interactive voice response (IVR) interaction channel and an in-person interaction channel.

5. The method of claim 1, further comprising:
establishing a browser-level or a tab-level socket connection, by the processor, for facilitating capturing of the interaction data and the non-interaction data related to the one or more interactions of the customer on a web interaction channel from among the plurality of interaction channels.

6. The method of claim 1, further comprising:
tracking, by the processor, tagged content associated with one or more websites visited by the customer during the one or more interactions of the customer on a web interaction channel from among the plurality of interaction channels for facilitating capturing of the interaction data and the non-interaction data.

7. The method of claim 1, further comprising:
facilitating, by the processor, a passing of interaction context related to the one or more interactions among two or more interaction channels from among the plurality of interaction channels to facilitate prediction of the intention based on interaction history across multiple interaction channels.

8. The method of claim 1, wherein the customized interaction experience is provided to the customer during the one or more interactions or in a subsequent customer interaction on the one or more interaction channels.

9. The method of claim 1, wherein providing the customized interaction experience to the customer in a web interaction channel comprises displaying a customer-intention specific version of a website to the customer.

10. The method of claim 9, wherein displaying the customer-intention specific version of the website to the customer comprises displaying one or more portions of website content relevant to the predicted intention of the customer substantially more prominently than one or more remaining portions of the website content.

11. The method of claim 1, wherein providing the customized interaction experience to the customer in an IVR interaction channel, a speech interaction channel or a chat interaction channel comprises precluding probing questions for inferring the customer's intentions and provisioning of options or questions relevant to the predicted intention of the customer.

12. An apparatus, comprising:
at least one processor; and
a memory having stored therein machine executable instructions, that when executed by the at least one processor, cause the apparatus to:
facilitate a capturing of interaction data and non-interaction data related to one or more interactions of a customer on at least one interaction channel from among a plurality of interaction channels, the interaction data comprising information related to elements of interest to the customer from among a plurality of elements presented to the customer during the one or more interactions, the non-interaction data comprising information related to one or more remaining elements of non-interest to the customer from among the plurality of elements presented to the customer during the one or more interactions;
predict an intention of the customer based on the interaction data and the non-interaction data; and
provide a customized interaction experience to the customer in one or more interaction channels from among the plurality of interaction channels based on the predicted intention of the customer.

13. The apparatus of claim 12, wherein the apparatus is further caused to determine the elements of interest to the customer based on customer actions related to at least one of:
selection of one or more options from among a plurality of options presented to the customer;
focus events or mouse rollover events indicative of the customer having viewed one or more content portions from among content displayed to the customer;
touch input events indicative of customer's preferences; and
at least one of verbal utterances and textual input events indicative of customers' interest.

14. The apparatus of claim 12, wherein the apparatus is further caused to determine the elements of non-interest to the customer based on at least one of:
one or more options not selected or de-selected from among a plurality of options presented to the customer;
one or more content portions not viewed from among content displayed to the customer;
touch event options ignored or skipped by the customer;
non-affirmative verbal utterances from the customer; and
textual input events indicative of customer's non-interest in the one or more remaining elements presented to the customer during the one or more interactions.

15. The apparatus of claim 12, wherein the apparatus is further caused to:
facilitate a passing of interaction context related to the one or more interactions among two or more interaction channels from among the plurality of interaction channels to facilitate prediction of the intention based on interaction history across multiple interaction channels.

16. The apparatus of claim 12, wherein providing the customized interaction experience to the customer in a web interaction channel comprises displaying a customer-intention specific version of a website to the customer.

17. The apparatus of claim 12, wherein providing the customized interaction experience to the customer in an IVR interaction channel, a speech interaction channel or a chat interaction channel comprises precluding probing questions for inferring the customer's intentions and provisioning of options or questions relevant to the predicted intention of the customer.

18. A non-transitory computer-readable medium storing a set of instructions that when executed cause a computer to perform a method comprising:
facilitating a capturing of interaction data and non-interaction data related to one or more interactions of a customer on at least one interaction channel from among a plurality of interaction channels, the interaction data comprising information related to elements of interest to the customer from among a plurality of elements presented to the customer during the one or more interactions, the non-interaction data comprising information related to one or more remaining elements of non-interest to the customer from among the plurality of elements presented to the customer during the one or more interactions;
predicting an intention of the customer based on the interaction data and the non-interaction data; and
providing a customized interaction experience to the customer in one or more interaction channels from among the plurality of interaction channels based on the predicted intention of the customer.

19. The computer-readable medium of claim 18, further comprising:
determining the elements of interest to the customer based on customer actions related to at least one of:
selection of one or more options from among a plurality of options presented to the customer;
focus events or mouse rollover events indicative of the customer having viewed one or more content portions from among content displayed to the customer;
touch input events indicative of customer's preferences; and
at least one of verbal utterances and textual input events indicative of customers' interest.

20. The computer-readable medium of claim 18, further comprising:
determining the elements of non-interest to the customer based on at least one of:
one or more options not selected or de-selected from among a plurality of options presented to the customer;
one or more content portions not viewed from among content displayed to the customer;
touch event options ignored or skipped by the customer;
non-affirmative verbal utterances from the customer; and
textual input events indicative of customer's non-interest in the one or more remaining elements presented to the customer during the one or more interactions

21. The computer-readable medium of claim 18, further comprising:
facilitating a passing of interaction context related to the one or more interactions among two or more interaction channels from among the plurality of interaction channels to facilitate prediction of the intention based on interaction history across multiple interaction channels.

22. The computer-readable medium of claim 18, wherein providing the customized interaction experience to the customer in a web interaction channel comprises displaying a customer-intention specific version of a website to the customer.

23. The computer-readable medium of claim 18, wherein providing the customized interaction experience to the customer in an interactive voice response (IVR) interaction channel, a speech interaction channel or a chat interaction channel comprises precluding probing questions for inferring the customer's intentions and provisioning of options or questions relevant to the predicted intention of the customer.
